(19) United States
(12) Patent Application Publication
(10) Pub. No.: US 2026/0303183 A1
(43) Pub. Date: Oct. 1, 2026

(54) INTER-CELL BEAM MANAGEMENT SCHEDULING RESTRICTION AND REPORTING

(71) Applicant: Intel Corporation, Santa Clara, CA (US)

(72) Inventors: Hua Li, Beijing 11 (CN); Meng Zhang, Beijing (CN); Rui Huang, Beijing (CN); In-Seok Hwang, Santa Clara, CA (US); Richard C. Burbidge, Shrivenham (GB)

(21) Appl. No.: 18/992,054

(22) PCT Filed: Aug. 8, 2023
(86) PCT No.: PCT/US2023/029757

§ 371 Date: Jan. 7, 2025

Related U.S. Application Data
(60) Provisional application No. 63/396,871, filed on Aug. 10, 2022.

(51) Int. Cl. H04B 7/06; H04B 17/318; H04L 5/00; H04W 48/08; H04W 72/044

(52) U.S. Cl. CPC H04B 7/06952; H04B 17/328; H04L 5/0092; H04W 48/08; H04W 72/046

(57) ABSTRACT

An apparatus and system are described for scheduling restriction of inter-cell Layer 1 Reference Signal Received Power (L1-RSRP) measurements when the Synchronization Signal Block (SSB) and data are scheduled in the same symbol. The scheduling restriction includes that the UE is not expected to receive downlink data or control signaling on symbols corresponding to SSB indexes configured for L1-RSRP measurement, where the data/control signals are transmitted by different cells and have the same subcarrier spacing (SCS) or have a different SCS and the UE supports simultaneousRxDataSSB-DiffNumerology. The cells include the UE serving cell and another cell that has a different physical cell identifier (PCI). For different SCS and no UE support of simultaneousRx-DataSSB-DiffNumerology, the UE is not expected to receive downlink data/control signaling or channel state information reference signals or transmit uplink data/control signaling or sounding reference signals on symbols corresponding to SSB indexes configured for L1-RSRP measurement.

### PRIORITY CLAIM

This application claims the benefit of priority to U.S. Provisional Patent Application Ser. No. 63/396,871, filed Aug. 10, 2022, which is incorporated herein by reference in its entirety.

### TECHNICAL FIELD

Embodiments pertain to next generation wireless communications. In particular, some embodiments relate to scheduling restrictions and user equipment (UE) reporting for inter-cell beam management.

### BACKGROUND

The use and complexity of NG systems, which include 5G networks and are starting to include sixth generation (6G) networks among others, has increased due to both an increase in the types of devices user equipment (UEs) using network resources as well as the amount of data and bandwidth being used by various applications, such as video streaming, operating on these UEs. With the vast increase in number and diversity of communication devices, the corresponding network environment has become increasingly complicated. As expected, a number of issues abound with the advent of any new technology, including complexities related to multi-cell beam management.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates overlapping between cells in accordance with some embodiments.

FIG. 4 illustrates overlapping between cells in accordance with some embodiments.

FIG. 5 illustrates a process of identifying signal overlap in accordance with some embodiments.

FIG. 6 illustrates a process of transmitting a signal to a UE in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

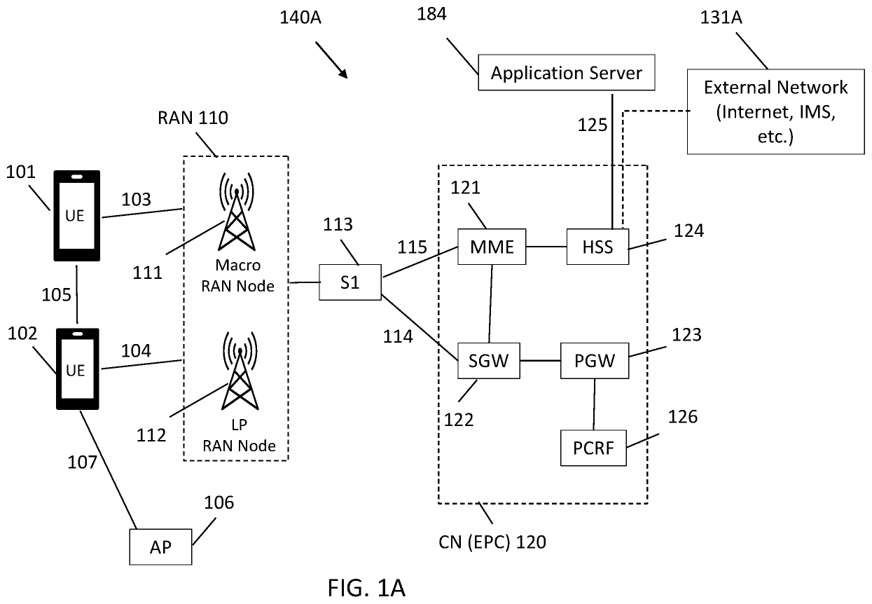

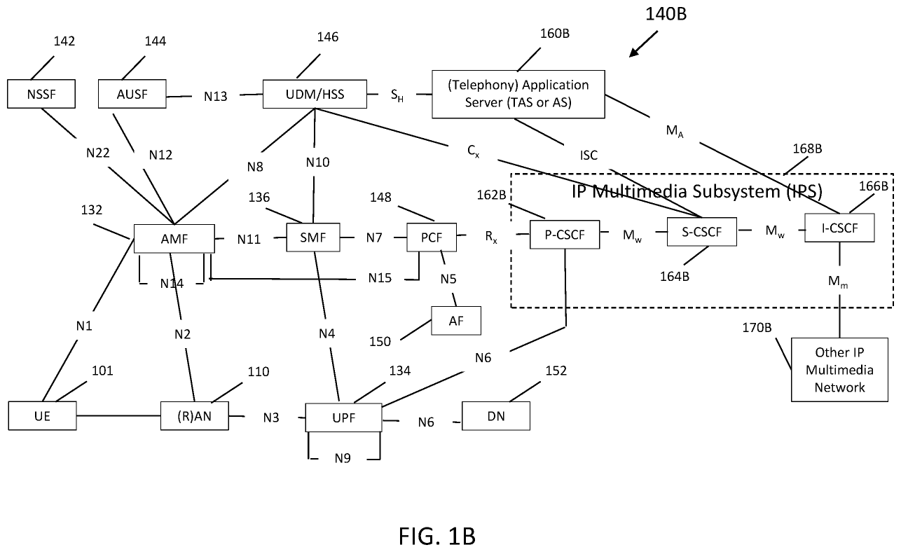

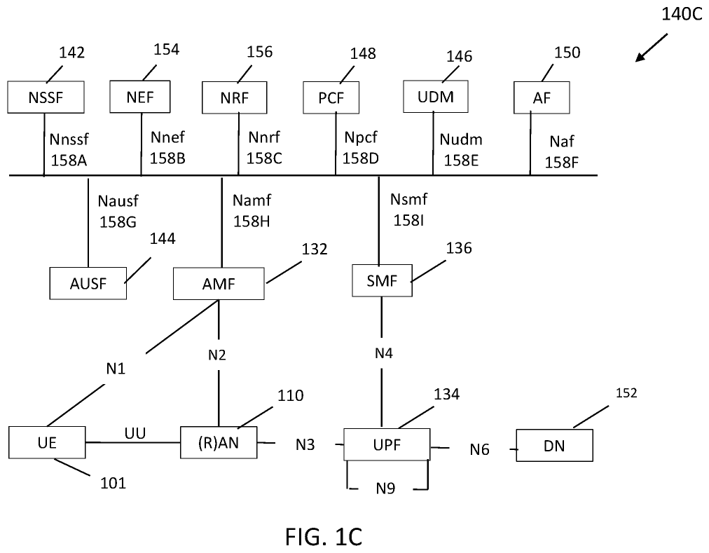

FIG. 1A illustrates an architecture of a network in accordance with some aspects. The network 140A includes 3GPP LTE/4 G and NG network functions that may be extended to 6G functions. Accordingly, although 5G will be referred to, it is to be understood that this is to extend as able to 6G structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IOT) UE or a Cellular IoT (CIOT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IOT (eNB-IOT) UE and Further Enhanced (FeNB-IOT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IOT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF can be communicatively coupled to the gNBs and the NG-eNBs via NG interfaces.

More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a primary node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs).

More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g., an IMS operated by a different network operator.

In some aspects, the UDM/HSS 146 can be coupled to an application server 184, which can include a telephony application server (TAS) or another application server (AS) 160B. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

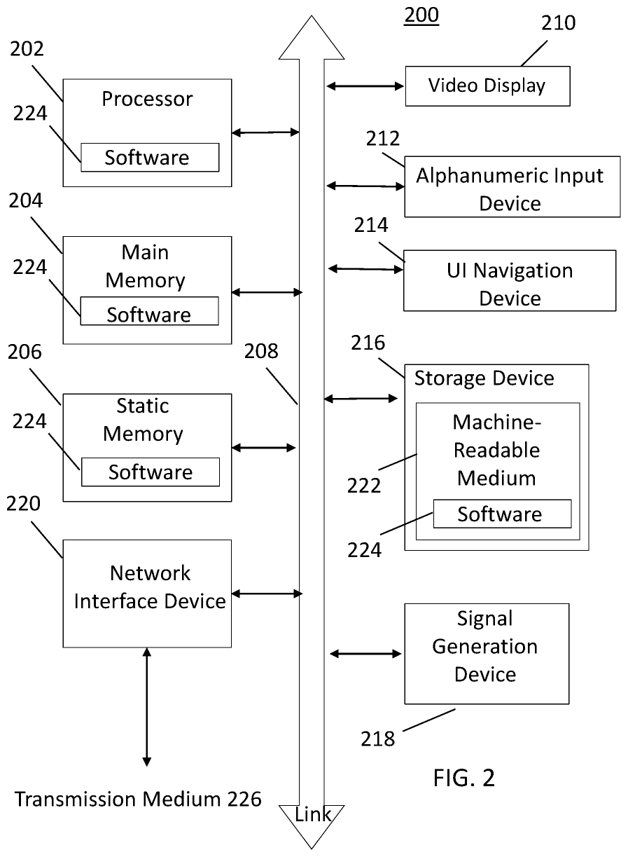

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single-or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre- 4th Generation) (3GPP Rel. 8(Pre-4 G)), 3GPP Rel. 9(3 rd Generation Partnership Project Release 9), 3GPP Rel. 10(3rd Generation Partnership Project Release 10), 3GPP Rel. 11(3rd Generation Partnership Project Release 11), 3GPP Rel. 12(3rd Generation Partnership Project Release 12), 3GPP Rel. 13(3rd Generation Partnership Project Release 13), 3GPP Rel. 14 (3rd Generation Partnership Project Release 14), 3GPP Rel. 15(3 rd Generation Partnership Project Release 15), 3GPP Rel. 16(3 rd Generation Partnership Project Release 16), 3GPP Rel. 17(3rd Generation Partnership Project Release 17) and subsequent Releases (such as Rel. 18, Rel. 19, etc.), 3GPP, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G 5A (i.e., Operation of ITS-G5 in European ITS frequency bands dedicated to ITS for safety related applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHZ)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHZ and further frequencies and SAS =Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHZ, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHZ, 610-790 MHz, 3400-3600 MHZ, 3400-3800 MHz, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHZ, 37-38.6 GHZ, 38.6-40 GHZ, 42-42.5 GHZ, 57-64 GHZ, 71-76 GHZ, 81-86 GHz and 92- 94 GHz, etc.), the ITS (Intelligent Transport Systems) band of 5.9 GHZ (typically 5.85-5.925 GHZ) and 63-64 GHz, bands currently allocated to WiGig such as WiGig Band 1 (57.24-59.40 GHZ), WiGig Band 2 (59.40-61.56 GHZ) and WiGig Band 3 (61.56-63.72 GHZ) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHZ spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, inter-cell beam management to form, control, and detect beams from a particular cell. In 5G NR Rel-15/Rel-16, a synchronization signal (SS)/physical broadcast channel (PBCH) Block (SSB) contains synchronization signals and is transmitted periodically. The SSB may be used for beam management purposes. Inter-Cell beam management may be based on the SSB, which may have different Cell IDs. In particular, layer 1 Reference Signal Received Power (L1-RSRP) measurements can be used for beam detection.

In some situations, physical downlink control channel (PDCCH) and/or physical downlink shared channel (PDSCH) transmissions may overlap an SSB. However, there is no scheduling restriction when a PDCCH/PDSCH is overlapped with an SSB configured for L1-RSRP on the same resource element (RE) for inter-cell beam management, which may result in a beam management issues. Accordingly, such overlapping may increase UE complexity and cause performance degradation.

In RAN4, a scheduling restriction occurs for inter-cell L1-RSRP when the SSB and data are scheduled in the same orthogonal frequency-division multiplexing (OFDM) symbol. In particular, a scheduling restriction exists to avoid the overlap of the SSB with data in the same symbol when the subcarrier spacing (SCS) between the SSB and data is different, and the UE does not support simultaneousRxDataSSB-DiffNumerology. There are no other limitations for other scenarios. The specification is as follows:

9.13.6.1 Scheduling Availability of UE Performing L1-RSRP Measurement with a Same Subcarrier Spacing as PDSCH/PDCCH on Frequency Range 1 (FR1)

There are no scheduling restrictions due to L1-RSRP measurement performed on SSB as RS for L1-RSRP measurement with the same SCS as PDSCH/PDCCH on serving cell(s) and cell(s) with PCI different from serving cell(s) in FR1.

9.13.6.2 Scheduling Availability of UE Performing L1-RSRP Measurement with a Different Subcarrier Spacing than PDSCH/PDCCH on FR1

For UEs that support simultaneousRxDataSSB-DiffNumerology there are no restrictions on scheduling availability due to L1-RSRP measurement based on SSB as RS for L1-RSRP measurement. For UEs that do not support simultaneousRxDataSSB-DiffNumerology the following restrictions apply due to L1-RSRP measurement based on SSB configured for L1-RSRP measurement.

The UE is not expected to transmit a physical uplink control channel (PUCCH)/physical uplink shared channel (PUSCH)/sounding reference signal (SRS) or receive a PDCCH/PDSCH/channel state information reference signal (CSI-RS) for tracking/CSI-RS for channel quality information (CQI) on symbols corresponding to the SSB indexes configured for L1-RSRP measurement, where the transmission of PUCCH/PUSCH/SRS and reception of PDCCH/PDSCH/CSI-RS for tracking/CSI-RS for CQI may be on serving cell(s) and cell(s) with PCI different from serving cell(s).

The scheduling restriction is not complete as there are other scenarios in which scheduling restrictions are desirable. In RAN4, since inter-cell beam management requirements are defined for known cell condition, the known condition are as follows:

A cell with a different physical cell ID (PCI) from a serving cell is considered as known if the following conditions are met in this requirement:

The SSB from the cell with the different PCI is completely contained in the active bandwidth part (BWP) or associated with an initial downlink BWP of the UE.

The SSB of the cell with the different PCI from the serving cell has the same SCS, sfn-SSB-Offset and center frequency as the SSB of the serving cell

The timing difference of arrival at the UE between the SSBs of the serving cell and the cell with different PCI is less than the cyclic prefix (CP) length of the corresponding SCS.

The UE has sent a valid L3 measurement report during the last 5 seconds.

The SSB from the cell with the different PCI remains detectable according to the cell identification requirements specified in clause 9.2.

It can be seen that the SSB offset is same for the two cells. However, since the periodicities of the SSB from the serving cell and the cell with the different PCI are different, it is possible that PDCCH/PDSCH reception from one cell may overlap with the SSB for L1-RSRP measurement from another cell on the same RE in the same symbol.

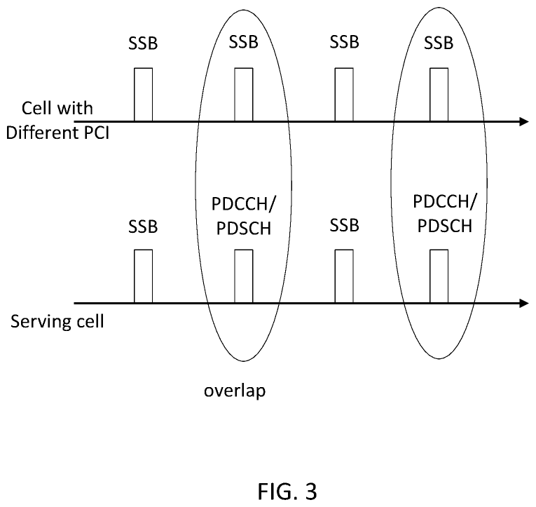

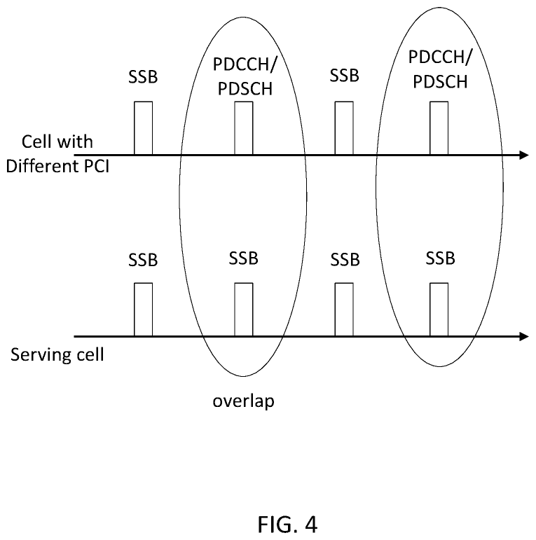

FIG. 3 illustrates overlapping between cells in accordance with some embodiments. FIG. 4 illustrates overlapping between cells in accordance with some embodiments. In FIG. 3, the data of the serving cell overlaps the SSB from the other cell on the same RE in the same symbol, as shown by the ovals. In FIG. 4, the SSB of the serving cell overlaps the data from the other cell on the same RE in the same symbol, as shown by the ovals.

When overlapping on the same RE occurs, performance degradation may occur, and additional UE complexities may be introduced if the UE is to perform measurement and date reception simultaneously. Thus, additional scheduling restrictions may be introduced to avoid overlapping.

These restriction may be defined as below:
Case 1: Scheduling availability of a UE performing L1-RSRP measurement with a same subcarrier spacing as PDSCH/PDCCH on FR1: When at least one RE of a PDCCH/PDSCH overlaps with at least one RE of a SSB configured for L1-RSRP measurement from a cell with a different PCI, the UE is not expected to receive the PDCCH/PDSCH on symbols corresponding to the SSB indexes configured for L1-RSRP measurement, where the reception of the PDCCH/PDSCH may be on the serving cell(s) and the cell(s) with PCI different from serving cell(s).
Case 2: Scheduling availability of a UE performing L1-RSRP measurement with a different subcarrier spacing than a PDSCH/PDCCH on FR1. For UEs that support simultaneousRxDataSSB-DiffNumerology: when at least one RE of a PDCCH/PDSCH overlaps at least one RE of a SSB configured for L1-RSRP measurement from a cell with a different PCI, the UE is not expected to receive a PDCCH/PDSCH on symbols corresponding to the SSB indexes configured for L1-RSRP measurement, where the reception of the PDCCH/PDSCH may be on the serving cell(s) and the cell(s) with the PCI different from the serving cell(s).

For UEs that do not support simultaneousRxDataSSB-DiffNumerology: the UE is not expected to transmit a PUCCH/PUSCH/SRS or receive a PDCCH/PDSCH/CSI-RS for tracking/CSI-RS for CQI on symbols corresponding to the SSB indexes configured for L1-RSRP measurement, where the transmission of the PUCCH/PUSCH/SRS and reception of the PDCCH/PDSCH/CSI-RS for tracking/CSI-RS for CQI may be on the serving cell(s) and the cell(s) with the PCI different from the serving cell(s).

Scheduling restrictions for L3 measurements may be updated similarly.

### UE Reporting Behavior

In current specification, the UE is requested to report a L1-RSRP result only under known cell conditions.

### 9.13.3 Measurement Reporting Requirements

The UE shall send L1-RSRP reports only for report configurations configured for the active BWP [for cell with different PCI from serving cell under the known cell condition. Otherwise, the UE shall not send L1-RSRP reports.]

The current definition about known cells is as follows:
A cell with a different PCI from a serving cell is considered as known if the following conditions are met:
   The SSB from the cell with the different PCI completely contained in the active BWP or associated with the initial downlink BWP of the UE,
      the SSB of the cell with the different PCI from the serving cell has the same SCS, sfn-SSB-Offset, and center frequency as the SSB of the serving cell,
      the timing difference of arrival at the UE between the SSBs of the serving cell and the cell with the different PCI is less than the CP length of the corresponding SCS,
      the UE has sent a valid L3 measurement report during the last 5 seconds, and
      the SSB from the cell with the different PCI remains detectable according to the cell identification requirements specified in clause 9.2.

Otherwise, the cell is unknown.

One special condition is related to a timing offset that may vary with time, costing an extra effort for the UE to calculate the timing offset and compare the timing offset with the CP length. Therefore, it may be more desirable not to limit the UE reporting behavior.

If the timing difference of arrival at the UE between the SSBs of the serving cell and cell with the different PCI is larger than the CP length, the UE is not required to report the L1-RSRP measurement. If the UE reports the L1-RSRP measurement, then the UE may not meet L1-RSRP measurement reporting requirements based on the accuracy requirements for the case when the timing offset is below the threshold.

In some embodiments, the legacy measurement restriction and scheduling restriction used for a non-serving cell may apply for an intra-frequency L1-RSRP measurement on a neighbor cell when the round trip delay of the serving cell and neighbor cell is within the CP.

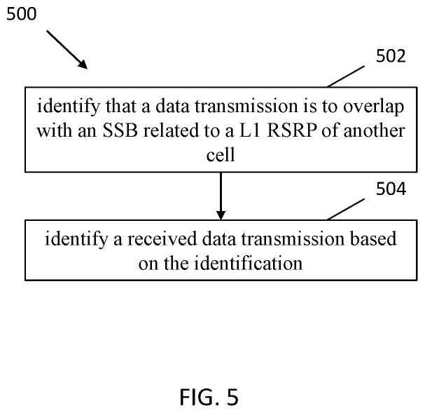

In some embodiments, the electronic devices, networks, systems, chips or components, or portions or implementations thereof, of the above figures may be configured to perform one or more processes, techniques, or methods as described herein, or portions thereof. One such process that may be performed by a UE, one or more elements of a UE, and/or one or more electronic devices that include or implement one or more elements of a UE is depicted in FIG. 5. FIG. 5 illustrates a process of identifying signal overlap in accordance with some embodiments. The process 500 may include identifying, at operation 502, that a data transmission is to overlap with a SSB related to a L1 RSRP of another cell; and identifying, at operation 504, a received data transmission based on the identification.

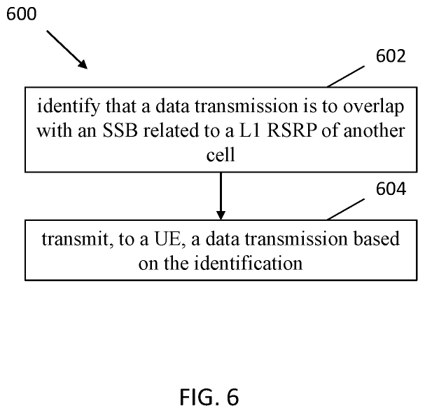

One such process that may be performed by a base station, one or more elements of a base station, and/or one or more electronic devices that include or implement one or more elements of a base station is depicted in FIG. 6. FIG. 6 illustrates a process of transmitting a signal to a UE in accordance with some embodiments. The process 600 may include identifying, at operation 602, that a data transmission is to overlap with a SSB related to a L1 RSRP of another cell; and transmitting, at operation 604, to a UE a data transmission based on the identification.

### EXAMPLES

Example 1 is an apparatus for a next generation (NG) network element, the apparatus comprising: processing circuitry to: determine a scheduling restriction for a user equipment (UE) that avoids overlap between a Synchronization Signal Block (SSB) for a Layer 1 Reference Signal Received Power (L1-RSRP) measurement and at least one of a physical downlink control channel (PDCCH) or a physical downlink shared channel (PDSCH); determine whether the SSB and the at least one of the PDCCH or PDSCH have different subcarrier spacings; and apply the scheduling restriction in response to a determination that the SSB and the at least one of the PDCCH or PDSCH have identical subcarrier spacings, application of the scheduling restriction being dependent on whether the SSB and the at least one of the PDCCH or PDSCH have different subcarrier spacings; and memory configured to store the scheduling restriction.

In Example 2, the subject matter of Example 1 includes, wherein the at least one of the PDCCH or PDSCH is from a serving cell and the SSB is from a cell with a different physical cell identifier (PCI) than the serving cell.

In Example 3, the subject matter of Examples 1-2 includes, wherein the SSB is from a serving cell and the at least one of the PDCCH or PDSCH is from a cell with a different physical cell identifier (PCI) than the serving cell.

In Example 4, the subject matter of Examples 1-3 includes, ).

In Example 5, the subject matter of Examples 1-4 includes, ).

In Example 6, the subject matter of Example 5 includes, wherein the processing circuitry is configured to: determine whether the UE supports simultaneousRxDataSSB-DiffNumerology; and apply the scheduling restriction in response to a determination that the UE supports simultaneousRxDataSSB-DiffNumerology.

In Example 7, the subject matter of Examples 5-6 includes, wherein the processing circuitry is configured to: determine whether the UE supports simultaneousRxDataSSB-DiffNumerology; and in response to a determination that the UE does not support simultaneousRxDataSSB-DiffNumerology, determine that the UE is not expected to, on symbols corresponding to SSB indexes configured for L1-RSRP measurement: transmit any of a physical uplink control channel (PUCCH), a physical uplink shared channel (PUSCH), and sounding reference signal (SRS), or receive the at least one of the PDCCH or PDSCH or a channel state information reference signal (CSI-RS) for tracking or channel quality information (CQI).

In Example 8, the subject matter of Examples 1-7 includes, -RSRP measurement to a serving cell of the UE to report configurations configured for an active bandwidth part (BWP).

In Example 9, the subject matter of Example 8 includes, -RSRP report by the UE may be avoided for a timing difference of arrival at the UE between SSBs of the serving cell and a cell with a different physical cell identifier (PCI) than the serving cell that is larger than a cyclic prefix (CP) length of a corresponding subcarrier spacing (SCS).

In Example 10, the subject matter of Example 9 includes, -RSRP measurement reporting requirements based on accuracy requirements.

Example 11 is an apparatus of a user equipment (UE), the apparatus comprising: processing circuitry to configure the UE to: receive, from one of a serving cell or another cell, a Synchronization Signal Block (SSB), the other cell having a different physical cell identifier (PCI) than the serving cell; receive, from another of the serving cell or the other cell, at least one of a physical downlink control channel (PDCCH) or a physical downlink shared channel (PDSCH), the SSB and the at least one of the PDCCH or PDSCH being subject to a scheduling restriction to avoid overlap between the SSB and the at least one of the PDCCH or PDSCH, the scheduling restriction dependent on whether the SSB and the at least one of the PDCCH or PDSCH have different subcarrier spacings; perform a Layer 1 Reference Signal Received Power (L1-RSRP) measurement based on the SSB; and send, to the serving cell, an L1-RSRP report that contains the L1-RSRP measurement dependent on a reporting restriction; and memory configured to store the scheduling restriction.

In Example 12, the subject matter of Example 11 includes), and the scheduling restriction is applied for the SSB and the at least one of the PDCCH or PDSCH having identical subcarrier spacings.

In Example 13, the subject matter of Examples 11-12 includes, wherein: the SSB and the at least one of the PDCCH or PDSCH have different subcarrier spacings and are transmitted in frequency range 1 (FR1); and the scheduling restriction is applied in response to the UE supporting simultaneousRxDataSSB-DiffNumerology.

In Example 14, the subject matter of Examples 11-13 includes, wherein: the SSB and the at least one of the PDCCH or PDSCH have different subcarrier spacings and are transmitted in frequency range 1 (FR1); and in response to the UE not supporting simultaneousRxDataSSB-DiffNumerology: determine that the UE is not expected to, on symbols corresponding to SSB indexes configured for L1-RSRP measurement: transmit any of a physical uplink control channel (PUCCH), a physical uplink shared channel (PUSCH), and sounding reference signal (SRS), or receive the at least one of the PDCCH or PDSCH or a channel state information reference signal (CSI-RS) for tracking or channel quality information (CQI).

In Example 15, the subject matter of Examples 11-14 includes, wherein the processing circuitry is configured to determine that the reporting restriction includes: limiting transmission of the L1-RSRP report to report configurations configured for an active bandwidth part (BWP); avoid transmission of the L1-RSRP report for a timing difference of arrival at the UE between SSBs of the serving cell and the other cell that is larger than a cyclic prefix (CP) length of a corresponding subcarrier spacing (SCS); and for a timing offset below the CP length, the L1-RSRP measurement in the L1-RSRP report may not meet L1-RSRP measurement reporting requirements based on accuracy requirements.

Example 16 is a non-transitory computer-readable storage medium that stores instructions for execution by one or more processors of a next generation (NG) network element, the one or more processors to, when the instructions are executed: determine a scheduling restriction for a user equipment (UE) that avoids overlap between a Synchronization Signal Block (SSB) for a Layer 1 Reference Signal Received Power (L1-RSRP) measurement and at least one of a physical downlink control channel (PDCCH) or a physical downlink shared channel (PDSCH); determine whether the SSB and the at least one of the PDCCH or PDSCH have different subcarrier spacings; and apply the scheduling restriction in response to a determination that the SSB and the at least one of the PDCCH or PDSCH have identical subcarrier spacings, application of the scheduling restriction being dependent on whether the SSB and the at least one of the PDCCH or PDSCH have different subcarrier spacings.

In Example 17, the subject matter of Example 16 includes, ).

In Example 18, the subject matter of Examples 16-17 includes, wherein: the SSB and the at least one of the PDCCH or PDSCH have different subcarrier spacings and are transmitted in frequency range 1 (FR1); and the instructions, when executed by the one or more processors, further configure the one or more processors to: determine whether the UE supports simultaneousRxDataSSB-DiffNumerology; and apply the scheduling restriction in response to a determination that the UE supports simultaneousRxDataSSB-DiffNumerology.

In Example 19, the subject matter of Examples 16-18 includes, wherein: the SSB and the at least one of the PDCCH or PDSCH have different subcarrier spacings and are transmitted in frequency range 1 (FR1); and the instructions, when executed by one or more processors, further configure the one or more processors to: determine whether the UE supports simultaneousRxDataSSB-DiffNumerology; and in response to a determination that the UE does not support simultaneousRxDataSSB-DiffNumerology, determine that the UE is not expected to, on symbols corresponding to SSB indexes configured for L1-RSRP measurement: transmit any of a physical uplink control channel (PUCCH), a physical uplink shared channel (PUSCH), and sounding reference signal (SRS), or receive the at least one of the PDCCH or PDSCH or a channel state information reference signal (CSI-RS) for tracking or channel quality information (CQI).

In Example 20, the subject matter of Examples 16-19 includes,-RSRP measurement dependent on a reporting restriction includes: limiting transmission of the L1-RSRP report to report configurations configured for an active bandwidth part (BWP); avoid transmission of the L1-RSRP report for a timing difference of arrival at the UE between SSBs of the serving cell and the other cell that is larger than a cyclic prefix (CP) length of a corresponding subcarrier spacing (SCS); and for a timing offset below the CP length, the L1-RSRP measurement in the L1-RSRP report may not meet L1-RSRP measurement reporting requirements based on accuracy requirements.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-20. (canceled)

21. A user equipment (UE) comprising:
processing circuitry to configure the UE to:
receive, from a serving cell and a neighbor cell having a different physical cell identifier (PCI), a Synchronization Signal Block (SSB) from each cell; and
based on a timing difference of arrival between the SSBs of the serving cell and the neighbor cell, restrict at least one of:
transmission of a physical uplink control channel (PUCCH), a physical uplink shared channel (PUSCH), and a sounding reference signal (SRS), and
reception of a physical downlink control channel (PDCCH), a physical downlink shared channel (PDSCH), and a channel state information reference signal (CSI-RS) for channel quality information (CQI); and
a memory configured to store the timing difference.

22. The UE of claim 21, wherein the processing circuitry configures the UE to restrict the at least one of the transmission and reception based further on whether the UE supports simultaneousRxDataSSB-DiffNumerology.

23. The UE of claim 22, wherein the processing circuitry configures the UE to restrict the at least one of the transmission and reception based on whether rxTimingDiff-r18 is supported.

24. The UE of claim 23, wherein the processing circuitry configures the UE to restrict the at least one of the transmission and reception on symbols that at least one of overlap or partially overlap with symbols corresponding to SSB indexes configured for Layer 1 Reference Signal Received Power (L1-RSRP) measurement based further on at least one of whether the UE supports simultaneousRxDataSSB-DiffNumerology and whether the UE supports rx TimingDiff-r18.

25. The UE of claim 24, wherein restriction of the at least one of the transmission and reception between the symbols that overlap with the symbols corresponding to the SSB indexes configured for L1-RSRP measurement and the symbols that overlap or partially overlap with the symbols corresponding to the SSB indexes configured for L1-RSRP measurement restriction is based further on the at least one of whether the UE supports simultaneousRxDataSSB-DiffNumerology and whether the UE supports rxTimingDiff-r18.

26. The UE of claim 24, wherein the processing circuitry configures the UE to restrict the at least one of the transmission and reception based further on whether the UE performs the L1-RSRP measurement with a different subcarrier spacing than the PDSCH and PDCCH.

27. The UE of claim 26, wherein the processing circuitry configures the UE to restrict the at least one of the transmission and reception based further on a frequency range being used for the at least one of the transmission and reception.

28. The UE of claim 27, wherein the frequency range is frequency range1 (FR1).

29. The UE of claim 22, wherein the processing circuitry configures the UE to:
determine a timing difference of arrival between the SSBs of the serving cell and the neighbor cell;
compare the timing difference of arrival to a cyclic prefix (CP) length associated with a subcarrier spacing of the SSBs; and
restrict the at least one of the transmission and reception dependent on a comparison between the timing difference of arrival and the CP length.

30. The UE of claim 21, wherein the processing circuitry configures the UE to indicate, to the serving cell, support of rxTimingDiff-r18.

31. A non-transitory computer-readable media having instructions, stored thereon, that when executed by one or more processors of a user equipment (UE) configure the UE to:
receive, from a serving cell and a neighbor cell having a different physical cell identifier (PCI), a Synchronization Signal Block (SSB) from each cell; and
based on a timing difference of arrival between the SSBs of the serving cell and the neighbor cell, restrict at least one of:
transmission of a physical uplink control channel (PUCCH), a physical uplink shared channel (PUSCH), and a sounding reference signal (SRS), and
reception of a physical downlink control channel (PDCCH), a physical downlink shared channel (PDSCH), and a channel state information reference signal (CSI-RS) for channel quality information (CQI); and
a memory configured to store the timing difference.

32. The non-transitory computer-readable media of claim 31, wherein the instructions, when executed by the one or more processors, configure the UE to restrict the at least one of the transmission and reception based further on whether the UE supports simultaneousRxDataSSB-DiffNumerology.

33. The non-transitory computer-readable media of claim 32, wherein the instructions, when executed by the one or more processors, configure the UE to restrict the at least one of the transmission and reception based on whether rxTimingDiff-r18 is supported.

34. The non-transitory computer-readable media of claim 33, wherein the instructions, when executed by the one or more processors, configure the UE to restrict the at least one of the transmission and reception on symbols that at least one of overlap or partially overlap with symbols corresponding to SSB indexes configured for Layer 1 Reference Signal Received Power (L1-RSRP) measurement based further on at least one of whether the UE supports simultaneousRxDataSSB-DiffNumerology and whether the UE supports rxTimingDiff-r18.

35. The non-transitory computer-readable media of claim 34, wherein restriction of the at least one of the transmission and reception between the symbols that overlap with the symbols corresponding to the SSB indexes configured for L1-RSRP measurement and the symbols that overlap or partially overlap with the symbols corresponding to the SSB indexes configured for L1-RSRP measurement restriction is based further on the at least one of whether the UE supports simultaneousRxDataSSB-DiffNumerology and whether the UE supports rxTimingDiff-r18.

36. The non-transitory computer-readable media of claim 34, wherein the instructions, when executed by the one or more processors, configure the UE to restrict the at least one of the transmission and reception based further on whether the UE performs the L1-RSRP measurement with a different subcarrier spacing than the PDSCH and PDCCH.

37. The non-transitory computer-readable media of claim 36, wherein the instructions, when executed by the one or more processors, configure the UE to restrict the at least one of the transmission and reception based further on a frequency range being used for the at least one of the transmission and reception.

38. The non-transitory computer-readable media of claim 37, wherein the frequency range is frequency range1 (FR1).

39. A serving cell comprising:
processing circuitry to configure the serving cell to:
transmit, to a user equipment (UE), a Synchronization Signal Block (SSB), and at least one of:
receive from the UE at least one of a physical uplink control channel (PUCCH), a physical uplink shared channel (PUSCH), and a sounding reference signal (SRS), and
transmit a physical downlink control channel (PDCCH), a physical downlink shared channel (PDSCH), and a channel state information reference signal (CSI-RS) for channel quality information (CQI), the at least one of reception and transmission restricted by the UE based on a timing difference of arrival between the SSB and an SSB from a neighbor cell having a different physical cell identifier (PCI) than the serving cell, and
a memory configured to store the timing difference.

40. The serving cell of claim 39, wherein:
restriction of the at least one of the transmission and reception is based further on whether the UE supports simultaneousRxDataSSB-DiffNumerology and whether rxTimingDiff-r18 is supported, and
the restriction includes one of:
symbols that overlap with symbols corresponding to SSB indexes configured for Layer 1Reference Signal Received Power (L1-RSRP) measurement, or
symbols that overlap or partially overlap with the symbols corresponding to the SSB indexes configured for the L1-RSRP measurement.
